(19) United States
(12) Patent Application Publication
(10) Pub. No.: US 2013/0339999 A1
(43) Pub. Date: Dec. 19, 2013

(54) Systems and Methods for Communal Broadcast Information Having Supplemental Data

(71) Applicants: John SanGiovanni, Seattle, WA (US); Ken Willner, (US)

(72) Inventors: John SanGiovanni, Seattle, WA (US); Ken Willner, (US)

(73) Assignee: Zumobi, Inc., Seattle, WA (US)

(21) Appl. No.: 13/527,483

(22) Filed: Jun. 19, 2012

(51) Int. Cl. H04N 21/43

(52) U.S. Cl. 725/34; 725/35; 725/32

(57) ABSTRACT

A device paired with a conventional television is used to display to a particular viewer information desired by that particular viewer even though the information displayed on the television is communally broadcast. In one embodiment, the device contains an application that allows communally broadcast information to be displayed on the paired television. If a user desires additional information pertaining to something observed on the television (such as an advertisement) the user, via the device, signals such a desire and the information is downloaded to the device specific to that device. The downloaded information, for example, could be based on demographics of the user, previously requested information, and/or simply the GPS location of the device.

### TECHNICAL FIELD

This disclosure relates to consumer electronic devices and more particularly to such devices that display communally broadcast information having supplemental data and even more specifically where the supplemental data is location specific.

### BACKGROUND

It is well-known that communal broadcast information, such as that provided by television, can have a local component thereto. This is typically accomplished by distributing the communal information from a central location to a plurality of individual locations. The centrally created data is then broadcast (or placed on a cable channel) by each such individual location. The individual locations can add locally relevant data (usually in substitution for blocks of data already existing as part of the centrally distributed information) to the broadcast information. In this manner, advertisements can be geared to local businesses, as opposed to being limited to national sponsors.

However, even with this system, all of the subscribers receiving the broadcast from a particular location will obtain the same data, with no subscriber receiving more or less data than any other subscriber.

### BRIEF SUMMARY

A device paired with a conventional television is used to display to a particular viewer information desired by that particular viewer even though the information displayed on the television is communally broadcast. In one embodiment, the device contains an application that allows communally broadcast information to be displayed on the paired television. If a user desires additional information pertaining to something observed on the television (such as an advertisement) the user, via the device, signals such a desire and the information is downloaded to that device. The downloaded information, for example, could be based on demographics of the user, previously requested information, the GPS location of the device, and the like.

In one embodiment, the pairing is such that the communally broadcast information is first received by the device and then communicated to the television. In other embodiments, the communal broadcast can be sent directly to the television and the device can be keyed to what is being viewed by external keys, such as, for example, applications that keep track of what the user is currently viewing on television.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIGS. 1 and 1A show one embodiment of a system using the concepts of this invention;

FIGS. 2 and 2A illustrate a specific program playing on the television as controlled by a remote device;

FIGS. 3, 3A, 3B and 3C illustrate supplemental information being delivered to the remote device, and;

FIG. 4 shows one embodiment of a method of operation of the concepts discussed herein.

### DETAILED DESCRIPTION

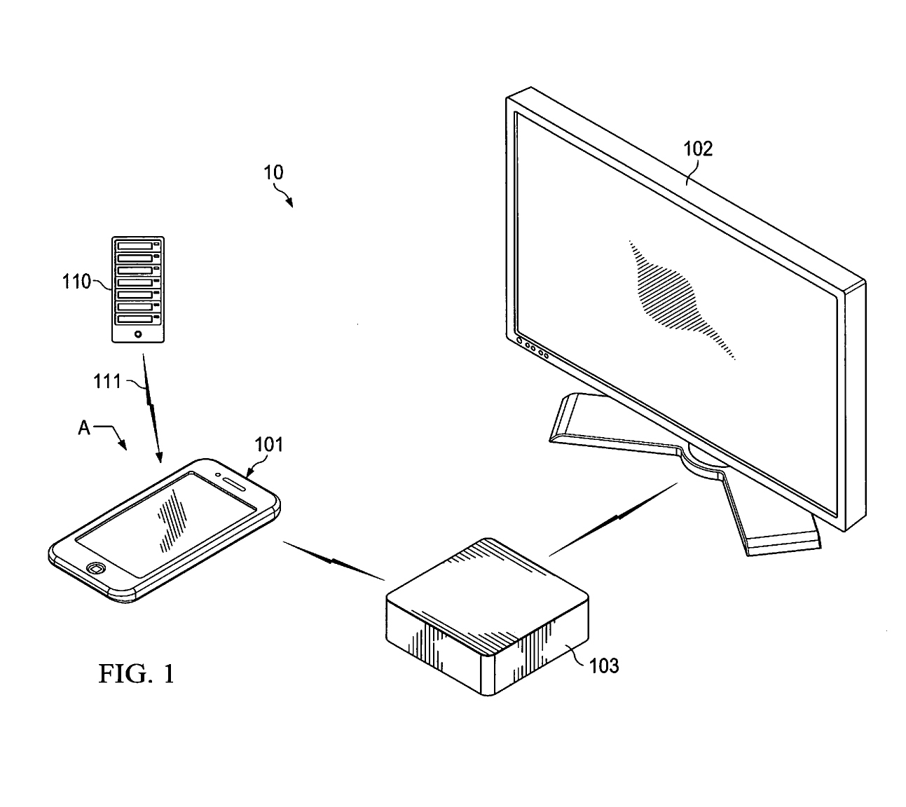

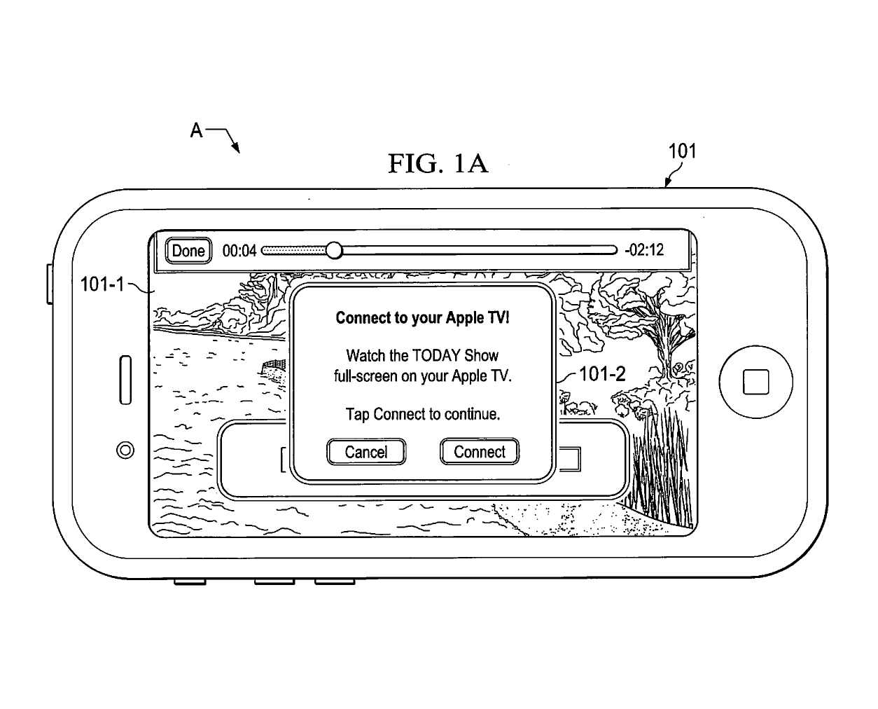

FIGS. 1 and 1A show one embodiment of a system 10 using the concepts of this invention such that remote device 101 is used to control image content appearing on television/monitor 102. In the embodiment shown, the control of television is via an intermediate device such as intermediate device 103. However, in some embodiments, the functionality of intermediate device 103 may be implemented within television 102. The television content be sent to intermediate device 103 in many different ways, such as via cable, Internet (WiFi), telephone line, wireless, etc. or, in some embodiments, from remote device 101. In some embodiments intermediate device 103 may be a streaming content device such as Apple TV®, Roku® device, and the like. Such devices may be configured to receive content from remote device 101 and pass such content to television 102.

In some embodiments, an application (APP) would be resident on remote device 101 and the user, by accessing the APP (as shown on FIG. 1A) can control various features, such as what program is being shown on television 102. In some situations, the selected program will go to television 102 from remote device 101, either directly or via an intermediate device, such as intermediate device 103, or the APP will control an intermediate control device (such as intermediate device 103) to select a program for viewing on television 102. Regardless of how the television program data arrives at television 102, in one embodiment it is important that remote device 101 (or the APP on the remote device) know which television program is being viewed at any point in time.

Coordination between remote device 101 and television 102 can occur in any manner, such as by receiving the television information on a hand-held device (such as device 101) and exchanging data with television 102. Coordination of program media appearing on television 102 and the APP running on the hand-held remote device 101 can instead be communicated to hand-held device 101 either manually, by the viewer or remotely from a central distribution source (not shown). Alternatively, the program information can be communicated directly from the television to the hand-held device.

In the embodiment of FIGS. 1 and 1A, programs (such as the TODAY show, can be selected by the user from remote device 101 (which can be a smart phone or tablet device, such as an iPad®, iPhone® or any other wireless or wired device with Internet access) and by operation of the APP, such as by using the CONNECT button on display image 101-2 (FIG. 1A), the TODAY show will be delivered to television 102.

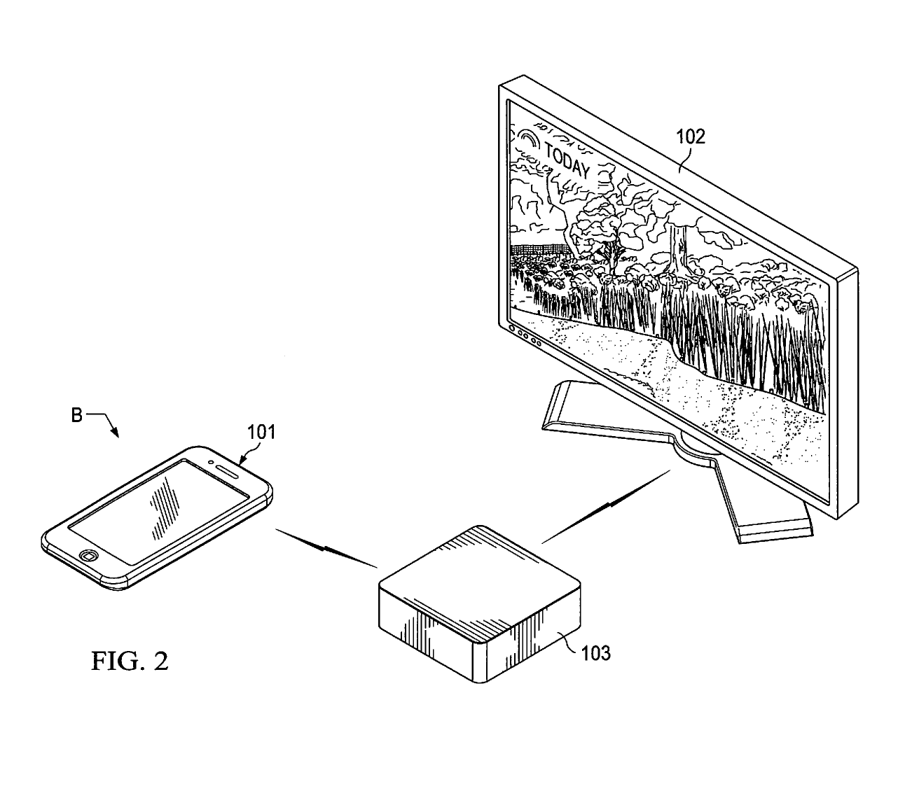

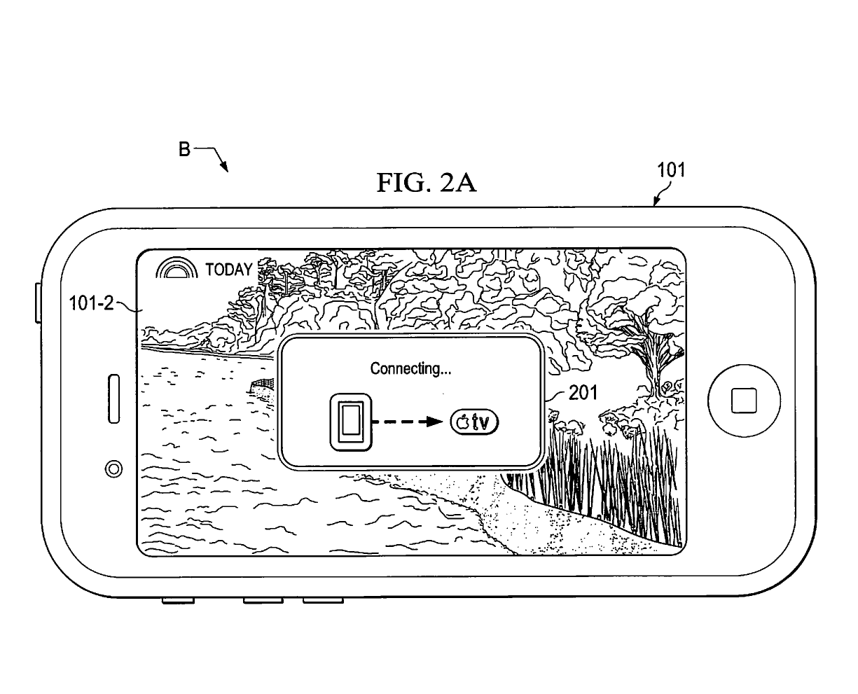

When the CONNECT button is pressed, remote device 101 connects with intermediate device 103 (in this example, an Apple TV® device as shown in display box 201 (FIG. 2A)) via an application running on the mobile device. When the respective devices are connected, the program being viewed on remote device 101 is sent to intermediate device 103 and then to television 102 for display. The APP allows a device user to send any content appearing on the screen of the mobile device to the television. Note that this is only one method of having the television display content selected by the user at a mobile device where the mobile device is not a device primarily designed for controlling the television (such as television remote would be). Display box 201 (not required), shows the user that the program is indeed being directed to television 102 under control of device 101. Note that device 101 has, as is well known, a processor and memory (not shown) for autonomously performing computing functions. Any APP loaded onto the device will be stored in memory and run under at least partial control of the device processor.

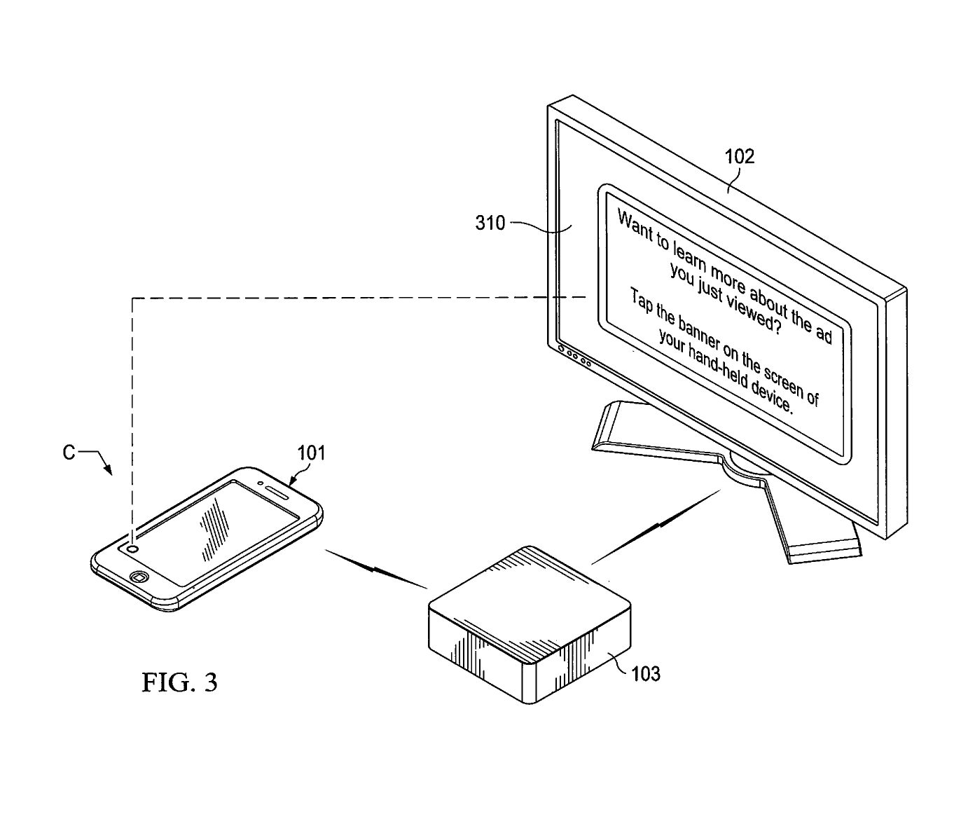

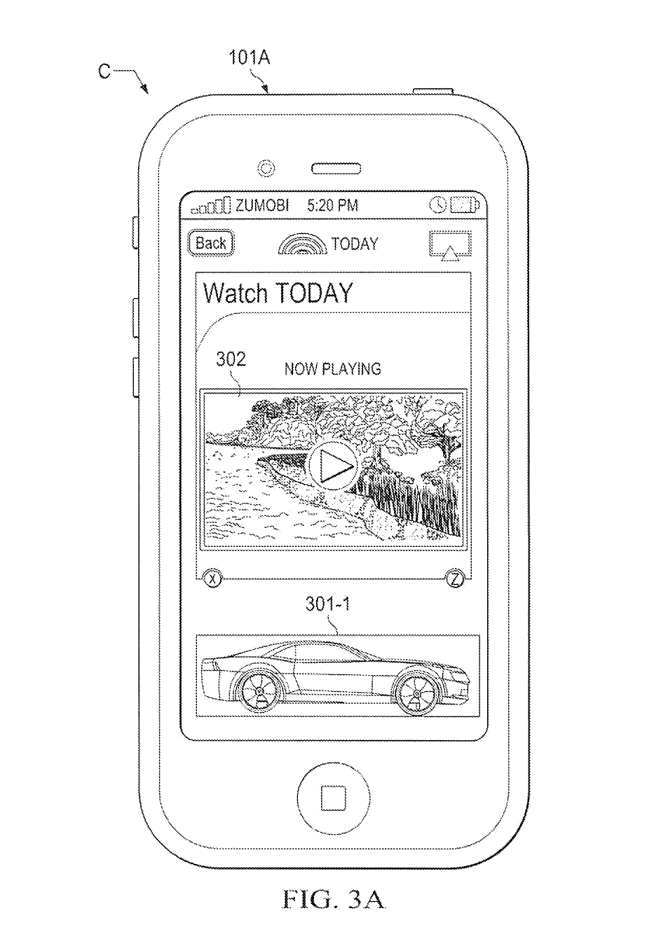

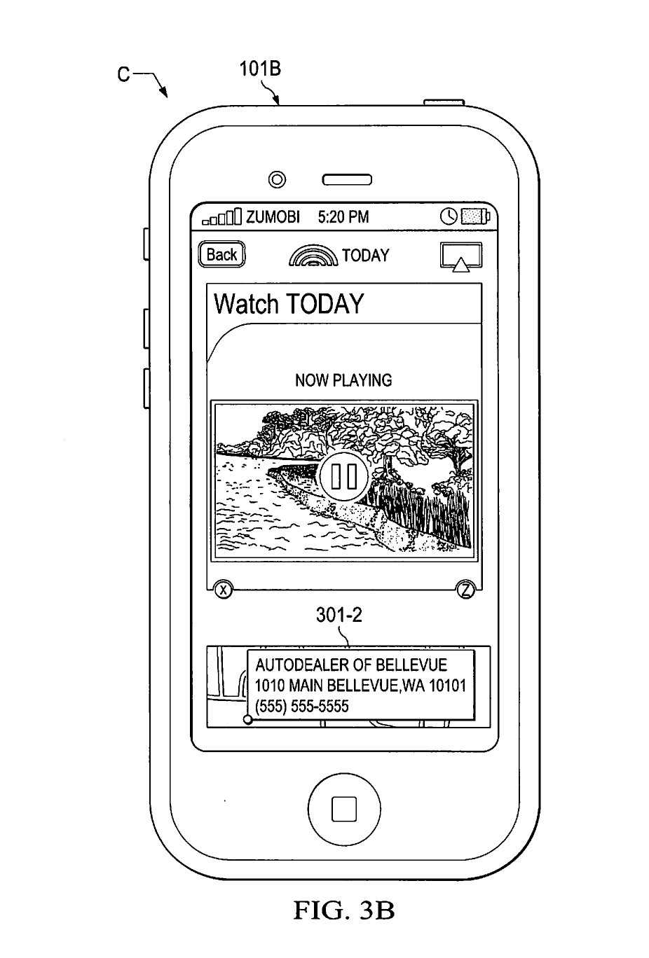

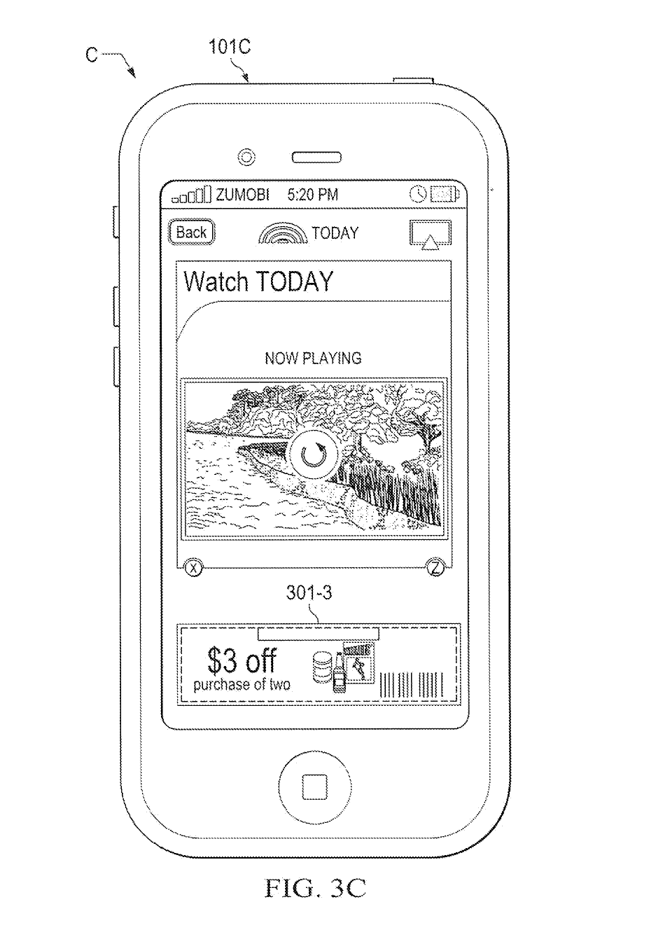

FIGS. 3, 3A, 3B and 3C illustrate supplemental information being delivered to a remote device (e.g. remote device 101), in this embodiment, from one or more servers 110 (FIG. 1) to augment what is displayed on television 102 at any particular time. In one embodiment, after the airing of a commercial (or any other information presentation) a banner may be displayed, such as shown on display 310, that directs the user's attention to device 101 (shown in FIGS. 3A, 3B and 3C as devices 101A, 101B or 101C, respectively. Such a banner may be presented for a brief period of time and may be presented in any form such as in a scrolling or static manner, and/or may be animated. The banner provides instructions as to how to receive additional information about a commercial that is playing (or has just played). Note, the additional information can pertain to any media presented on the television screen and need not be confined to commercials.

Remote device 101A (FIG. 3A) shows a car, such as car 301-1, which is an expansion of the commercial just shown on television 102. This expanded view (or expanded details) of the car is delivered to remote device 101, in one embodiment, via the Internet and is timed to correspond to what is being shown on the television (or about to be shown or previously shown). In one embodiment, dialog box 302 allows the user to pause or continue playing what is being shown on the television. This then allows the user time to interact with the extra material without missing anything on the main television display. It is noted that in the illustrated embodiment, the video content playing on the television is also displayed on remote device 101A, however, the controls for the video content may be included on remote device 101A while leaving additional display space for other content, such as content relating to the advertisement. If desired, the user may be able to interact with image 301-1, for example, rotate the view, change the color, learn about pricing and even perhaps order the product, all with controls (not shown) displayed on the screen of remote device 101A.

In one embodiment, the user is in control of whether or not the information on the main television continues playing or is placed on hold via remote device 101. The same is true for the sound. Thus, the user might allow the video to continue on the main screen while muting the main television sound so as to listen to sound from the remote device. In some situations, sound from both devices might be used concurrently and in some situation, this concurrent sound can be an enhancement if desired.

In some embodiments, the system can use the GPS (or other location determination methods) commonly found in mobile devices to determine the location of the device. Thus, it is possible customize content delivered to the mobile device based on location information. For example, as shown in banner 301-2 of remote device 101B, (shown in FIG. 3B) upon receiving an automobile advertisement, text may be included which shows the nearest car dealer with respect to the present location of the mobile device. Maps showing directions to the displayed location can be displayed if desired, all using commonly known technology, but triggered by timing from a particular television program playing on the viewer's television. This supplemental information, as discussed above, is downloaded to remote device 101 from one or more servers 110 which are accessed via the well-known telephony/Internet network via link(s) 111.

In some embodiments, content sent to remote device 101 may include special offers directed to a consumer. For example, coupon 301-3, shown on remote device 101C (FIG. 3C) can be sent to a particular viewer in order to provide promotions via the viewed advertisements. Coupon 301-3 may be particularly directed to a user based on information compiled from the types of devices used in system 10, settings of the APP, etc. For example, coupons or promotions may be based on demographics of the user and/or the user's device. Additionally, a coupon could be based upon location of the device, activity or other parameters of the device. If desired, the downloaded coupon can be saved, perhaps to the home screen of the device or perhaps to an application resident on the device (or at a common server) so that the coupon can be used at a later time by the user.

In some embodiments, advertisements broadcast during program viewing may be supplemented to the mobile device with additional content provided by an alternate advertiser. For example, a local advertiser can add content to a national advertisement in a manner that more specifically directs a viewer toward an advertised product.

For instance, an automobile manufacturer might insert an advertisement for a vehicle at a particular time into a national broadcast. The user, from the mobile device (with or without a prompt from the television screen), could be directed to his/her mobile device or be directed to touch a button on his/her mobile device, which contains additional information. The mobile device, knowing its own location, and knowing what program is being aired on the television at the time of the screen touch, can go to a server, such as server 110, to retrieve information relating to what is or has been displayed. The retrieved information can be, for example, locally created for a specific vendor. Also, there could be multiple available displays, all of which can be shown to the user, or the user can be allowed to pick which one or ones he/she wishes to view. Thus, vendors having relevant data can have information directed to a user whenever the user asks for additional data while viewing the automobile manufacturer commercial.

As noted above, any method of knowing what is on the television screen at any given time can be used to trigger whether information will be provided to the requesting user having a mobile device. One method of knowing what is being displayed is to have a time-line log available at the server, the time-line log keyed to commercial products and perhaps to products shown in the program. Other methods may include utilizing recognition software which recognizes that sound or data streaming to the television. Embodiments are not limited by the means wherein data is recognized, provided, or how devices may be paired in order to provide the described content.

Note that once the user requests additional information via a mobile device, that information can emanate from a plurality of sources and be available on the user's mobile device. The user can take advantage of all of the features native to his/her own device as well as using features provided by APPS loaded on the mobile device. Note also, once the additional material is present on the mobile device it is possible to communicate that additional material to the television itself in addition to, or in place of, what is already being viewed on the television. Using such a feature, it could be possible to override the normal television program (the broadcast programming) with enhanced information obtained locally by the user. The information override (modification) could be audio and/or video. Thus, a viewer can, under control of an APP on the user's device, translate the language being heard from the television from the native language of the program to a language preferred by a viewer. In one embodiment, the APP would do live translation and delay the visual long enough to accomplish the translation.

The additional information, whether displayed only on the mobile device or on both, can come from any number of locations, including from third parties live or pre-stored. Thus, in some situations, the user, by indicating he/she desires more information could, in fact, open a text (or even a voice) dialog with a third party (or perhaps even another viewer or a social network “friend” for the purpose of obtaining additional information.

Any information coming to the mobile device could be streamed to the television if desired or to another mobile device using the native abilities of the mobile device. For example, it may be possible to send multiple images to the television, one from each APP running on the mobile device and a third APP could coordinate how the images are to appear on the television. Note that the coordination of how the material plays on the television could be by a set-top box (not shown) or any other device which receives communications from the user's personal device and delivers content to the television. The embodiment shown box 103 (FIG. 1) can perform this function.

WiFi communication between the mobile device and the television (perhaps via an intermediary device) is what is expected, but any form of communication link will work. Also note that more than one mobile device could become linked to one television (or to many televisions). In such a situation, any of the devices could send programming to the television, and the users at each device, driven by prompts from the television, could download different additional material. For example, consider an advertisement showing a car being driven through a park. An adult viewer might want more information from a local car dealer, while a child might wish information on the video game being played by a child in the video.

Expanding this example, assume a baseball game is being displayed on the television under control from a first mobile device belonging to a one user. Another user's mobile device is also linked into the connection such that the first user can obtain statistics about the team standings while the second user might want to see video clips of the last at-bat for the current batter.

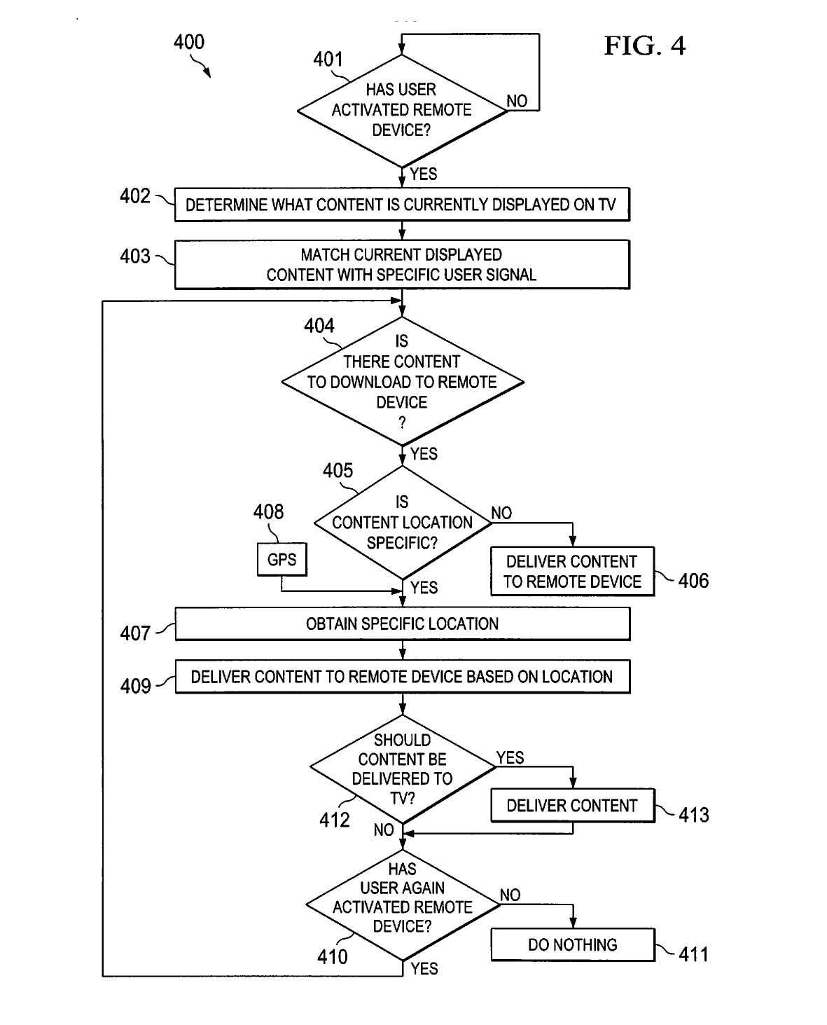

FIG. 4 shows one embodiment of method 40 of operation of the concepts discussed herein. It is noted that various steps of method 40 may be implemented concurrently or in a different order. The flow of method 40 illustrates an example of how inventive concepts described herein may be implemented.

Method 40 assumes that television is displaying information content and that a user having a remote device is present. In the context of this application, the remote device is a device that is primarily designed and used for activities other than controlling televisions (e.g. an iPad®, Android® tablet, smart phone, etc.).

Method 40 further assumes that the television has displayed, or otherwise communicated to the user, that additional information is available by using the remote device. Process 401 determines if the user has activated his/her remote device in response signaling a desire for additional information. If so, then process 402 determines what content is currently being displayed on the television. As discussed, determination of content can be accomplished in a number of different ways, for example, by timing and knowing what content was just on the television. Knowledge of content can be mechanical, in that knowledge of what television channel (or other source of the content) can yield, perhaps from a database file, what the content is based on the time. Content can be determined by image analysis (under control of an APP in the remote device or at another remote location) or perhaps by markers or tags placed in the media and delivered along with the “additional information desired” signal to a processing system. Process 403, working in conjunction with process 402, matches the current displayed content with the user's signal.

Process 404 determines if there is additional content appropriate for the time and place of the remote device. If there is more than one such content then a determination must be made under control of process 404 as to which content is appropriate. This determination can be interactive or it can be based on previous profiles or other demographics of the user at the remote device. If the content is not location (or any other demographic specific), as determined by process 405, then process 406 delivers the selected additional media to the remote device.

When the content is location specific (or specific to a particular profile or demographic) then process 407 with the help of features of the remote device, such as GPS 408, obtains the specification to assist in determining which additional content to deliver. Thus, for location-specific content the nearest dealer could be selected. Process 409 delivers the appropriate media to the user's remote device. Process 412 determines if it is necessary to deliver all or part of the additional content to the television (for example, for translation purposes). If so, process 413 controls the delivery and coordination of that content. Process 412 would also serve to delay television content to allow for processing time of additional content, if required.

Process 410 ends the method if the additional media has been delivered and the user is not requesting any further information. If the user is requesting additional information, then the method continues at process 404.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of providing supplemental media to a television user, said method comprising:
sending, from a device external to said television, to'a server separate from both said remote device and said television, a request for media supplemental to media displayed on said television at a particular point in time; and
receiving available supplemental media at said external device, said supplemental media obtained via said server, said received supplemental media coordinated with said media displayed on said television at said particular time.

2. The method of claim 1 further comprising:
establishing from said external device what media is displayed on said television at any given time.

3. The method of claim 2 wherein said establishing and said receiving are controlled, at least in part, by applications downloaded from a site other than said television or a site controlled by said television.

4. The method of claim 3 wherein said external device is a communication device not necessarily associated with said television.

5. The method of claim 2 wherein said received media is also coordinated with the geographical location of said remote device.

6. The method of claim 2 wherein said received media is also coordinated with data obtained regarding the user of said remote device.

7. The method of claim 1 further comprising:
communicating at least a portion of said received media to said television.

8. The method of claim 1 further comprising:
controlling the playback of media displayed on said television upon receiving said supplemental media.

9. The method of claim 1 wherein the supplemental media comprises promotional offers which are directed to a user.

10. A system for allowing a user to obtain supplemental data pertaining to media presented to said user on a television, said system comprising:
a non-television specific device remote from said television for controlling what media is currently being displayed on said television;
a link to at least one remote network for requesting delivery of media supplemental to and time coordinated with media displayed on said television; and
means for communicating delivered supplemental media to said user.

11. The system of claim 10 wherein said non-television specific device is a device for communicating primarily with devices other than said television.

12. The system of claim 11 wherein said communicating means comprises a display screen on said remote device.

13. The system of claim 11 wherein said communicating means comprises a transmission link to said television for display of said supplemental media on said television.

14. The system of claim 11 wherein said supplemental media is media that enhances a specific television image displayed to said user.

15. The system of claim 11 further comprising:
means for coordinating a specific television image with potential supplemental media.

16. The system of claim 11 further comprising:
means for communicating to said remote network a physical location of said non-television specific device so as to allow selection of said supplemental media to be based, at least in part, on said physical location.

17. The system of claim 11 further comprising:
means for communicating to said remote network biometric data from said non-television specific device so as to allow selection of said supplemental media to be based, at least in part, on said biometric data.

18. An application for downloading to a communication device for allowing said communication device to provide supplemental media to a user, said supplemental media coordinated with program media displayed on a television remote from said communication device, said application comprising:
a computer program for storage in memory on said communication device and for running on a processor, said computer program comprising code for causing said processor to:
display on a viewing screen of said device controls for allowing a user of said device to control which programs are displayed on said television;
display on a viewing screen of said device controls for allowing said user to request supplemental media to augment media displayed on said television; and
display on said viewing screen received supplemental media.

19. The application as set forth on claim 18 wherein said computer program code is further operable to:
include in said request biometric data pertaining to either said user or said communication device in said request such that any returned supplemental media is based, at least in part on said biometric data as well as on what media is displayed on said television.

20. The application as set forth on claim 18 wherein said computer program code is further operable to:
include in said request data pertaining to what media is being presented at a time of said request.

21. The application as set forth on claim 18 wherein said computer program code is further operable to:
communicate at least a portion of said received supplemental media to said television.

22. The application as set forth on claim 21 wherein said computer program code is further operable to:
include in said last-mentioned communicated media comprising translation of speech data allowing for a substitution of a language native to media being presented on said television at said particular time to another language.
